(19) United States
(12) Patent Application Publication
(10) Pub. No.: US 2026/0112764 A1
(43) Pub. Date: Apr. 23, 2026

(54) POWER STORAGE MODULE

(71) Applicant: KABUSHIKI KAISHA TOYOTA JIDOSHOKKI, Aichi (JP)

(72) Inventors: Makoto SAKAGUCHI, Aichi (JP); Kazuki MAEDA, Kariya-shi, Aichi (JP); Kojiro TAMARU, Aichi (JP)

(73) Assignee: KABUSHIKI KAISHA TOYOTA JIDOSHOKKI, Aichi (JP)

(21) Appl. No.: 19/142,423

(22) PCT Filed: Oct. 20, 2023
(86) PCT No.: PCT/JP2023/038010

§ 371 Date: Jun. 23, 2025

(30) Foreign Application Priority Data
Dec. 26, 2022 (JP) 2022-208140

(51) Int. Cl. H01M 50/325; H01M 50/291

(52) U.S. Cl. CPC H01M 50/325; H01M 50/291; H01M 2200/20

(57) ABSTRACT

A power storage module includes a module main body in which electrodes are stacked in a first direction, a frame, and a pressure control valve attached to the frame having first communication holes in communication with internal spaces. The pressure control valve includes a wall body that has second communication holes in communication with the first communication holes, respectively, a protrusion that surrounds each of the second communication holes separately, the second communication holes being opened at a first wall surface, and valve bodies that close the second communication holes. A recess is formed to be recessed in a direction away from the frame and along the valve bodies, in a region of the first wall surface surrounded by the protrusion and having an opening of one of the second communication holes, the region not overlapping with the valve bodies as viewed in a second direction.

### TECHNICAL FIELD

The present disclosure relates to a power storage module.

### BACKGROUND ART

Patent document 1 discloses a power storage module. The power storage module includes a module main body having an electrode stack in which a plurality of bipolar electrodes are stacked, and a frame surrounding the electrode stack and having a first communication hole in communication with an internal space formed in the electrode stack, and a pressure control valve attached to the module main body, and having a second communication hole in communication with the first communication hole. The pressure control valve includes an elastic member that has a sealing surface closing the second communication hole, and a recess that is in communication with the second communication hole and formed in the sealing surface.

### CITATION LIST

### Patent Literature

[Patent Document 1] Japanese Patent Application Publication No. 2019-192547

### SUMMARY OF THE INVENTION

### Technical Problem

In this technical field, it is desired to efficiently permeate gas generated inside a cell to an outside of the power storage module without activating the pressure control valve. In the above power storage module, a surface area of a space of the pressure control valve in communication with the internal space is increased by forming the recess in the elastic member functioning as a valve body of the pressure control valve, thereby increasing an amount of gas permeation to the outside of the power storage module through the pressure control valve when gas is generated in the internal space. However, forming the recess in the elastic member, as in the above power storage module, may impair a function of the elastic member as the valve body, and is therefore undesirable. In addition, since an energy density of the power storage module is reduced, it is undesirable to increase a size of the pressure control valve in order to increase the surface area of the space in the pressure control valve in communication with the internal space.

The present disclosure is directed to providing a technique that increases an amount of gas permeation to an outside of the power storage module while an increase in size of a power storage module is suppressed.

### Solution to Problem

The power storage module according to one aspect of the present disclosure includes a module main body having an electrode stack in which a plurality of electrodes are stacked in a first direction, and a frame that surrounds the electrode stack and seals a plurality of internal spaces formed between the plurality of electrodes disposed side by side in the first direction; and a pressure control valve is provided. The frame has a plurality of first communication holes in communication with the plurality of internal spaces, respectively, and opened at an outer surface of the frame. The pressure control valve includes: a wall body that faces the frame, is made of resin, and includes a plurality of second communication holes in communication with the plurality of first communication holes, respectively; a protrusion that protrudes from a first wall surface of the wall body facing the outer surface of the frame toward the frame along a second direction intersecting with the first direction, and surrounds each of the plurality of second communication holes, separately, the plurality of second communication holes being opened at the first wall surface; and a plurality of valve bodies that close the plurality of second communication holes, respectively, from a second wall surface of the wall body opposite from the first wall surface. A recess is formed to be recessed in a direction away from the frame and along the valve bodies, in a region of the first wall surface of the wall body surrounded by the protrusion and having an opening of one of the plurality of second communication holes, the region not overlapping with the plurality of valve bodies as viewed in the second direction.

In the above power storage modules, a cell is formed by the electrodes disposed side by side in the first direction. A portion of the gas generated in the internal space of the cell can permeate the wall body facing intermediate spaces. Since the recess is formed in the wall surface of the wall body, a surface area of the wall surface exposed to the intermediate spaces is increased, as compared with a case where the wall surface is formed flat. As a result, a path for gas permeation is increased, thereby increasing the amount of gas permeating to an outside of the pressure control valve. Since the recess is formed along the valve bodies in the region that does not overlap with the valve bodies, a space formed by the pressure control valve can be used effectively, which suppresses an increase in size of a power storage module.

The plurality of valve bodies may have a columnar shape, and the protrusion may surround each of the second communication holes separately, in a rectangular frame shape as viewed in the second direction. In this configuration, since the protrusion has a rectangular frame shape and the valve bodies each have a circular shape, a region where the valve bodies are not disposed is easily formed in a region inside of the protrusion, and a space for forming the recess is easily secured.

As viewed in the second direction, at least a portion of the edge portion of the recess may be formed along the shape of the peripheral edges of the valve bodies. In this configuration, paths for gas permeation connecting a region where the recess is disposed and a region where the valve bodies are disposed may be efficiently formed.

The plurality of valve bodies may be arranged along a third direction, which intersects with the first direction and the second direction, and positions of the valve bodies disposed side by side in the third direction may be shifted from each other in the first direction. In this configuration, the valve bodies disposed side by side in the third direction are arranged obliquely to the third direction, which easily creates spaces for forming the recess.

### Advantageous Effects of Invention

According to the present disclosure, it is possible to provide a technology that can increase the amount of gas permeating to an outside of the power storage module while reducing the size of the power storage module.

### BRIEF DESCRIPTION OF DRAWINGS

FIG. 1 is a cross-sectional view illustrating a power storage device according to one example.

FIG. 2 is a cross-sectional view taken along line II-II of FIG. 1.

FIG. 3 is a cross-sectional view illustrating a power storage module according to one example.

FIG. 4 is a perspective view illustrating the power storage module according to the one example.

FIG. 5 is a plan view of a side surface of a main body forming the power storage module according to the one example.

FIG. 6 is an exploded perspective view illustrating a part of the power storage module according to the one example.

FIG. 7 is an exploded perspective view illustrating a pressure control valve according to the one example.

FIG. 8 is a plan view of a cover according to the one example.

FIG. 9 is a plan view of a case according to the one example.

FIG. 10 is a bottom view of the case according to the one example.

FIG. 11 is a cross-sectional view, taken along line XI-XI of FIG. 10.

FIG. 12 is a bottom view of the case according to another example.

FIG. 13 is a cross-sectional view, taken along line XIII-XIII of FIG. 12.

### DESCRIPTION OF EMBODIMENTS

The following will describe an embodiment of the present disclosure in detail with reference to the accompanying drawings. In the description of the drawings, the same reference signs are used for the same or equivalent parts, and the repeated descriptions are omitted. In the drawings, a XYZ Cartesian coordinate system may be shown as required. In one example, the Z-axis direction is a vertical direction, and the X-axis direction (second direction and third direction) and the Y-axis direction (first direction) are horizontal directions.

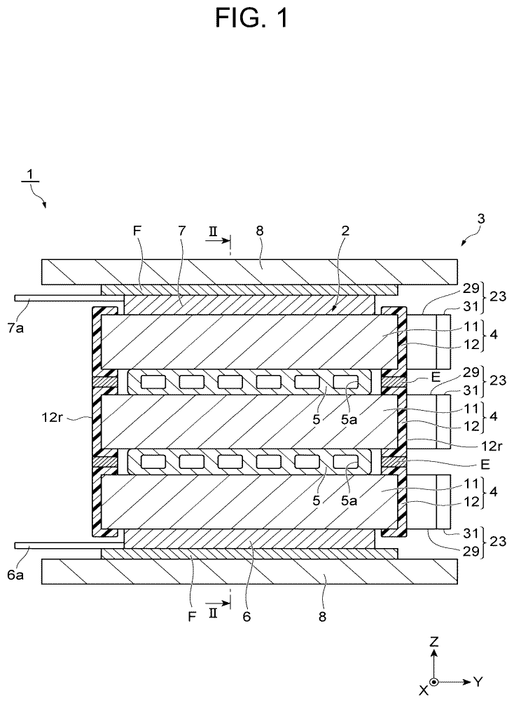

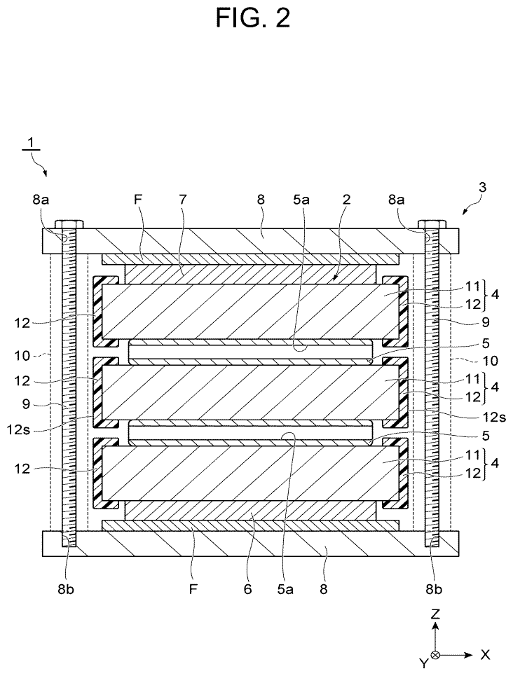

FIGS. 1 and 2 each are a cross-sectional view illustrating a power storage device including a power storage module according to an embodiment. FIG. 1 illustrates a cross-section perpendicular to the X-axis direction. FIG. 2 illustrates a cross-section taken along line II-II of FIG. 1, i.e., perpendicular to the Y-axis direction. A power storage device 1 illustrated in FIGS. 1 and 2 may be used as a battery for various vehicles such as a forklift truck, a hybrid vehicle, and an electric vehicle. The power storage device 1 includes a module stack 2 in which a plurality of power storage modules 4 are stacked along the Z-axis direction, and a constraining member 3 that applies a constraint load to the module stack 2 along the Z-axis direction.

The module stack 2 includes a plurality of power storage modules 4 (three power storage modules 4 in the present embodiment), and a plurality of conductive plates 5 (two conductive plates 5 in the present embodiment). The power storage modules 4 each are, for example, a bipolar battery, and has a rectangular shape, as viewed in the Z-axis direction. In one example, the power storage modules 4 each have a rectangular shape having long sides and short sides as viewed in the Z-axis direction. The power storage modules 4 each are, for example, a secondary battery such as a nickel-metal hydride battery, a lithium-ion battery, and a lead battery, or an electric double layer capacitor. In the following description, the nickel-hydrogen secondary battery will be described as an example.

The conductive plates 5 are disposed between the power storage modules 4 disposed side by side along the Z-axis direction. As a result, the plurality of power storage modules 4 are electrically connected via the conductive plates 5. For example, the power storage modules 4 each have a positive terminal surface on one end surface in the Z-axis direction and a negative terminal surface on the other end surface in the Z-axis direction, and the power storage modules 4, which are stacked with the conductive plates 5 interposed therebetween, are connected in series. A current collector plate 6 from which a positive terminal 6a is drawn out is disposed outside one of the power storage modules 4 positioned on one end of the module stack 2 in the Z-axis direction. The current collector plate 6 is electrically connected to such one of the power storage modules 4 A current collector plate 7 from which a negative terminal 7a is drawn out is disposed outside one of the power storage modules 4 positioned on the other end of the module stack 2 in the Z-axis direction. The current collector plate 7 is electrically connected to such one of the power storage modules 4 The power storage device 1 is charged and discharged using the positive terminal 6a and the negative terminal 7a.

Inside the conductive plates 5, a plurality of flow paths 5a are provided for circulating refrigerant such as air. For example, the flow paths 5a extend along a direction (the X-axis direction in the present embodiment) that crosses (perpendicularly) the Z-axis direction and a drawn-out direction in which the positive terminal 6a and the negative terminal 7a are drawn out. The conductive plates 5 each function not only as a connecting member that electrically connects the power storage modules 4 to each other, but also as a heat dissipation member that allows refrigerant to circulate through the flow paths 5a to dissipate heat generated in the power storage modules 4.

The constraining member 3 includes a pair of constraining plates 8 between which the module stack 2 is sandwiched in a stacking direction, a plurality of fastening members 9 such as bolts that connect the constraining plates 8 to each other by fastening, and pillars 10 accommodating body portions of the fastening members 9 (e.g., a shafts of the bolts). The constraining plates 8 each are a metal plate having a rectangular shape, the area of which is greater than that of each of the power storage modules 4 and the conductive plates 5 as viewed in the first direction. The constraining plates 8 each have a rectangular shape having long sides and short sides, as viewed in the Z-axis direction. An insulating member F having a plate shape is provided on an inner surface (a surface on the module stack 2 side) of each of the constraining plates 8. That is, the current collector plate 6 or the current collector plate 7, and the insulating member F are interposed between the module stack 2 and one of the constraining plates 8. This provides insulation between the constraining plates 8 and the module stack 2 (the current collector plates 6, or the current collector plate 7).

In an edge portion of one of the constraining plates 8, insertion holes 8a are formed at positions outward relative to the module stack 2 as viewed in the Z-axis direction, and in an edge portion of the other of the constraining plates 8, threaded holes 8b are formed at positions corresponding to the insertion holes 8a. The fastening members 9 are inserted from the insertion holes 8a of the one of the constraining plates 8 into the threaded holes 8b of the other of the constraining plates 8, and screwed into the threaded holes 8b of the other of the constraining plates 8. As a result, the power storage modules 4 and the conductive plates 5 are sandwiched between the constraining plates 8 and unitized as the module stack 2, and a constraint load is applied to the module stack 2 in the Z-axis direction.

In this way, the fastening members 9 are disposed outside the module stack 2, extend along the Z-axis direction, and fasten the pair of constraining plates 8 to each other in the Z-axis direction, thereby constraining the module stack 2. The pillars 10 are interposed between the pair of constraining plates 8 and extend, together with the fastening members 9, along the Z-axis direction. The pillars 10 define a distance between the pair of constraining plates 8 in the Z-axis direction, thereby defining a constraint force applied to the module stack 2. In the power storage device 1, a plurality of sets of one fastening member 9 and one pillar 10 accommodating the one fastening member 9 are arranged along the long sides of the constraining plates 8, as viewed in the Z-axis direction. Additionally, the fastening members 9 and the pillars 10 face each other in a direction along the short sides of the constraining plates 8, as viewed in the Z-axis direction.

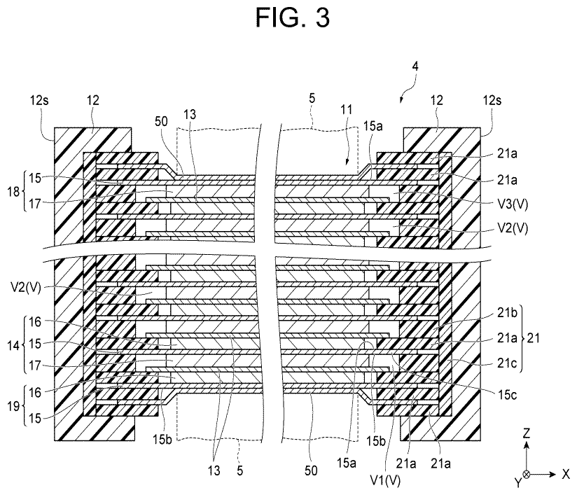

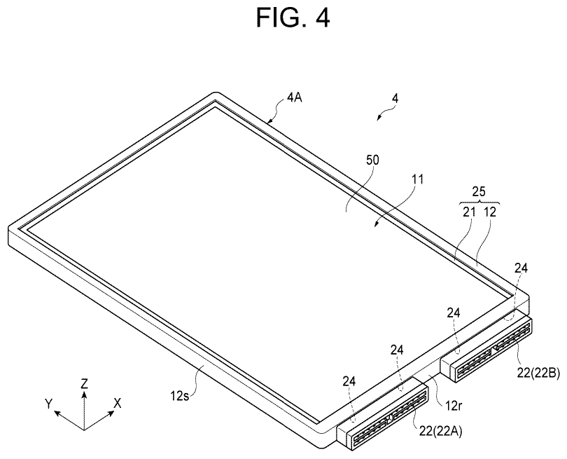

Next, the configuration of the power storage modules 4 will be described in detail. FIG. 3 is a cross-sectional view illustrating the power storage module. FIG. 4 is a perspective view illustrating the power storage module. The power storage modules 4 each have a structure (a multi-cell structure) in which a plurality of cells (e.g., 24 cells) are stacked with the Z-axis direction as the stacking direction. The power storage modules 4 each include a module main body 4A and a plurality of pressure control valves 22 (two pressure control valves 22 in the present embodiment) attached to the module main body 4A. The module main body 4A includes an electrode stack 11 and a frame 25 that is disposed so as to surround the electrode stack 11. The electrode stack 11 includes a plurality of electrodes stacked with separators 13 disposed therebetween along the Z-axis direction. The electrode stack 11 illustrated as an example includes one negative terminal electrode 18, one positive terminal electrode 19, and a plurality of bipolar electrodes 14 (intermediate electrodes) positioned between the negative terminal electrode 18 and the positive terminal electrode 19 as a plurality of electrodes. A stacking direction of the electrodes may coincide with that of the module main body 4A.

The bipolar electrodes 14 each include an electrode plate 15 having a first surface 15a and a second surface 15b opposite from the first surface 15a, a positive electrode active material layer 16 provided on the first surface 15a, and a negative electrode active material layer 17 provided on the second surface 15b. In the electrode stack 11, the positive electrode active material layer 16 of one of the bipolar electrodes 14 faces the negative electrode active material layer 17 of another of the bipolar electrodes 14 that is disposed adjacent to the one of the bipolar electrodes 14 in the Z-axis direction with one of the separators 13 interposed therebetween. In the electrode stack 11, the negative electrode active material layer 17 of one of the bipolar electrodes 14 faces the positive electrode active material layer 16 of another of the bipolar electrodes 14 that is disposed adjacent to the one of the bipolar electrodes 14 in the Z-axis direction with one of the separators 13 interposed therebetween.

The negative terminal electrode 18 includes the electrode plate 15 and the negative electrode active material layer 17 provided on the second surface 15b of the electrode plate 15. No active material layer is provided on the first surface 15a of the electrode plate 15 of the negative terminal electrode 18. The negative terminal electrode 18 is disposed at one end of the electrode stack 11 in the Z-axis direction so that the second surface 15b is on an inner side of the electrode stack 11 (a side facing the center in the Z axis direction). The negative electrode active material layer 17 of the negative terminal electrode 18 faces the positive electrode active material layer 16 of one of the bipolar electrodes 14 at the one end in the Z-axis direction with one of the separators 13 interposed therebetween.

The positive terminal electrode 19 includes the electrode plate 15, and the positive electrode active material layer 16 provided on the first surface 15a of the electrode plate 15. No active material layer is provided on the second surface 15b of the electrode plate 15 of the positive terminal electrode 19. The positive terminal electrode 19 is disposed at the other end of the electrode stack 11 in the Z-axis direction so that the first surface 15a is on the inner side of the electrode stack 11. The positive electrode active material layer 16 of the positive terminal electrode 19 faces the negative electrode active material layer 17 of one of the bipolar electrodes 14 at the other end in the Z-axis direction with one of the separators 13 interposed therebetween.

The first surface 15a of the electrode plate 15 of the negative terminal electrode 18 is a surface facing an outside of the electrode stack 11. One of the conductive plates 5 is electrically connected to the first surface 15a of the negative terminal electrode 18 via a metal plate 50. The second surface 15b of the electrode plate 15 of the positive terminal electrode 19 is a surface facing the outside of the electrode stack 11. The other of the conductive plates 5 is electrically connected to the second surface 15b of the positive terminal electrode 19 via a metal plate 50.

The electrode plate 15 is made of a metal such as nickel or a nickel-plated steel plate. In one example, the electrode plate 15 is a rectangular metal foil made of nickel. The electrode plate 15 has a peripheral edge portion 15c (peripheral edge portions of the bipolar electrodes 14, the negative terminal electrode 18, and the positive terminal electrode 19) that has a rectangular frame shape and is an area where neither the positive electrode active material layer 16 nor the negative electrode active material layer 17 is formed. For example, nickel hydroxide is used as a positive electrode active material forming the positive electrode active material layer 16. For example, hydrogen storage alloy is used as a negative electrode active material forming the negative electrode active material layer 17.

The separators 13 each have a sheet shape, for example. For example, a porous film made of a polyolefin-based resin such as polyethylene (PE), polypropylene (PP) and a woven fabric or a nonwoven fabric made of polypropylene, polyethylene terephthalate (PET), methylcellulose, or the like may be used for the separators 13. The separators 13 may be reinforced with a vinylidene fluoride resin compound.

The frame 25 is made of, for example, an insulating resin, and has a rectangular tubular shape as a whole. The frame 25 is provided in the electrode stack 11 so as to surround the peripheral edge portions 15c of the electrode plates 15. The frame 25 includes a plurality of first seal portions 21 connected to the peripheral edge portions 15c of the electrode plates 15, and a second seal portion 12 extending along the stacking direction and connected to each of the first seal portions 21. The first seal portions 21 and the second seal portion 12 are made of, for example, an insulating resin, and may be made of polypropylene (PP), polyphenylene sulfide (PPS), modified polyphenylene ether (modified PPE), or the like.

The first seal portions 21 each include a first portion 21a, a second portion 21b, and a third portion 21c. The first portion 21a has a rectangular frame shape as viewed in the Z-axis direction, and is connected (e.g., welded) to the peripheral edge portion 15c of the electrode plate 15. The second portion 21b has a rectangular frame shape as viewed in the Z-axis direction, and is disposed on a portion of the first portion 21a. As viewed in the Z-axis direction, an inner edge of the second portion 21b is located outward relative to an inner edge of the first portion 21a. A peripheral edge portion of each of the separators 13 is connected (e.g., welded) to its associated first portion 21a.

The third portion 21c has a rectangular tubular shape extending along the Z-axis direction, and connects the first portions 21a with the second portions 21b to each other so as to be integrated. The first portions 21a and the second portion 21b may be formed by folding a single sheet member, for example. In this case, the third portion 21c is a welding end portion formed by welding a folded portion of the sheet member (outer ends of the first portions 21a and the second portion 21b), for example.

The second seal portion 12 is made of, for example, an insulating resin, and has a generally rectangular tubular shape. As viewed in Z-axis direction, the second seal portion 12 is provided around the electrode stack 11 so as to surround the electrode stack 11. The second seal portion 12 is connected (e.g., welded) to the first seal portions 21 so as to surround the first seal portions 21 from the outside. The second seal portion 12 is formed, for example, by injection molding of a resin, and extends over the entire length of the electrode stack 11 along the Z-axis direction. The second seal portion 12 is welded to outer surfaces of the first seal portions 21, for example, by heat generated at the injection molding.

The first seal portions 21 and the second seal portion 12 provide sealing between the bipolar electrodes 14 disposed side by side along the Z-axis direction, between the negative terminal electrode 18 and one of the bipolar electrodes 14, and between the positive terminal electrode 19 and one of the bipolar electrodes 14. Thus, internal spaces V, which are hermetically partitioned, are formed between the bipolar electrodes 14, between the negative terminal electrode 18 and one of the bipolar electrodes 14, and between the positive terminal electrode 19 and one of the bipolar electrodes 14. In other words, the frame 25 disposed so as to surround the electrode stack 11 forms the internal spaces V between a plurality of electrode plates 15 disposed side by side in the Z-axis direction, and also seals each of the internal spaces V. The internal spaces V each contain electrolyte (not illustrated) made of an alkaline solution such as an aqueous solution of potassium hydroxide. At least a portion of the electrolyte may be impregnated into the separators 13, the positive electrode active material layer 16, and the negative electrode active material layer 17. It is noted that the module main body 4A of one example has twenty four internal spaces V. In the following description, one of the internal spaces V formed between the positive terminal electrode 19 and one of the bipolar electrodes 14 disposed side by side with the positive terminal electrode 19 may be referred to as a first internal space V1, the internal spaces V formed between the bipolar electrodes 14 disposed side by side to each other may be each referred to as a second internal space V2, and one of the internal spaces V formed between the negative terminal electrode 18 and one of the bipolar electrodes 14 disposed side by side with the negative terminal electrode 18 may be referred to as a third internal space V3.

As illustrated in FIGS. 1 to 4, the second seal portion 12 includes a pair of outer surfaces 12s each extending along a long side of each of the power storage modules 4 and a pair of outer surfaces 12r connecting the outer surfaces 12s to each other. The outer surfaces 12s and the outer surfaces 12r are surfaces extending along the Z-axis direction. Here, the outer surfaces 12s are surfaces that intersect with (perpendicular to) the X-axis direction, and the outer surfaces 12r are surfaces that intersect with (perpendicular to) the Y-axis direction. Furthermore, a length of each of the outer surfaces 12s in the Y-axis direction is longer than a length of each of the outer surfaces 12r in the X-axis direction. In the above-described conductive plates 5, the flow paths 5a extend along the X-axis direction and are opened in a pair of surfaces of the conductive plate 5 which intersect with the X-axis direction.

Therefore, gaps between the power storage modules 4 disposed side by side on the outer surfaces 12s side of the second seal portion 12 are used for introducing and discharging refrigerant into and from the flow paths 5a (refrigerant passes through the gaps). On the other hands, gaps between the power storage modules 4 disposed side by side on the outer surfaces 12r side of the second seal portion 12 are not used for introducing and discharging refrigerant into and from the flow paths 5a. Therefore, in the module stack 2, the gaps between the power storage modules 4 disposed side by side on the outer surfaces 12s side of the second seal portion 12 are opened, and the gaps between the power storage modules 4 disposed side by side on the outer surfaces 12r side are sealed with sealing materials E.

Here, the power storage modules 4 each may include a pair of metal plates 50. In the present embodiment, the metal plates 50 are provided at one end (an end on the negative terminal electrode 18 side) and the other end (an end on the positive terminal electrode 19 side) of the electrode stack 11 in the Z-axis direction. One of the pair of metal plates 50 is in contact with the first surface 15a of the electrode plate 15 of the negative terminal electrode 18 and its associated one of the conductive plates 5. The other of the pair of metal plates 50 is in contact with the second surface 15b of the electrode plate 15 of the positive terminal electrode 19 and its associated one of the conductive plates 5. In this way, in the power storage modules 4, the metal plates 50 are provided further outside the negative terminal electrode 18 and the positive terminal electrode 19. One of the metal plates 50 disposed at the one end in the Z-axis direction (on the negative terminal electrode 18 side) serves as a negative terminal surface of each of the power storage modules 4. The other of the metal plates 50 disposed at the other end in the Z-axis direction (on the positive terminal electrode 19 side) serves as a positive terminal surface of each of the power storage modules 4.

A peripheral edge portion of the one of the pair of metal plates 50 is held between one first portion 21a of one of the first seal portions 21 provided on the electrode plate 15 of the negative terminal electrode 18 and another first portion 21a facing the one first portion 21a. These paired first portions 21a are connected (e.g., welded) to each other with the third portion 21c to be integrated. A peripheral edge portion of the other of the pair of metal plates 50 is held between one first portion 21a of the first seal portions 21 provided on the electrode plate 15 of the positive terminal electrode 19 and another first portion 21a facing the one first portion 21a. These paired first portions 21a are also connected (e.g., welded) to each other with the third portion 21c to be integrated. The metal plates 50 each are a metal foil (uncoated foil) corresponding to the electrode plate 15 having no active material layer.

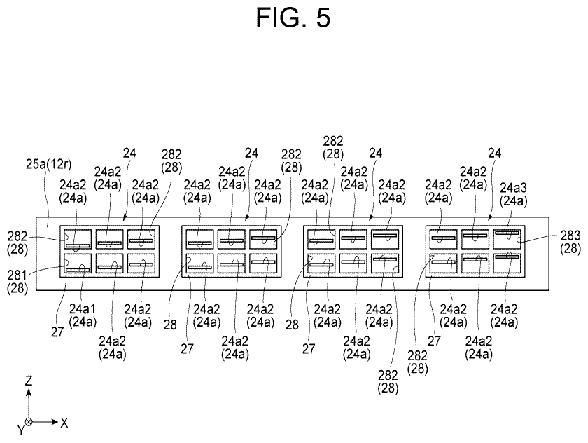

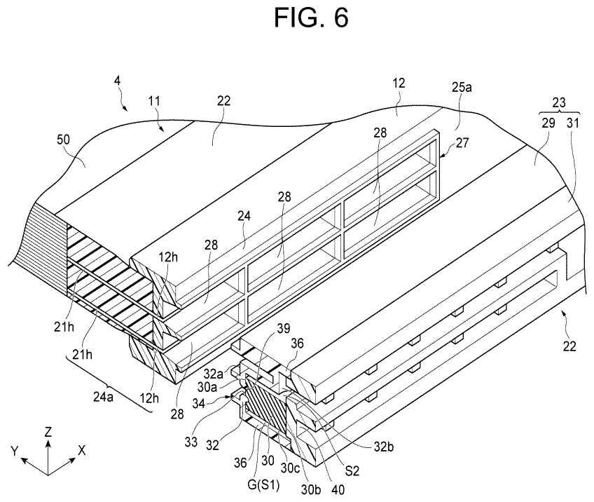

FIG. 5 illustrates a wall portion 25a of the frame 25 forming the module main body 4A. FIG. 6 is an exploded perspective view illustrating a portion of one of the power storage modules 4. As illustrated in FIGS. 4 to 6, the wall portion 25a (one of the outer surfaces 12r of the second seal portion 12) is provided with a plurality of attaching regions 24 (four attaching regions 24 in the present embodiment) for attaching the pressure control valves 22. The attaching regions 24 are spaced from one another in the X-axis direction. In one example, one pressure control valve 22 is attached to two attaching regions 24 disposed side by side in the X-axis direction.

In each of the attaching regions 24, the frame 25 has communication holes 24a (first communication holes) in communication with the internal spaces V (see FIG. 3). The attaching regions 24 each are provided with a plurality of communication holes 24a (six communication holes 24a in the present embodiment). The communication holes 24a are arranged in two rows so that each row has three communication holes 24a (three communication holes 24a in the Y-axis direction, two communication holes 24a in the Z-axis direction) in each of the attaching regions 24. Thus, the communication holes 24a are arranged in two rows so that each row has twelve communication holes 24a in the wall portion 25a. The communication holes 24a are in communication with their associated internal spaces V of different cells, and opened at one of the outer surfaces 12r.

Specifically, one of the attaching regions 24 at the left end in the illustration in FIG. 5 has a communication hole 24a1 and a plurality of communication holes 24a2 (five communication holes 24a2 in the present embodiment). In FIG. 5, two of the attaching regions 24 disposed inward in the X-axis direction have only a plurality of communication holes 24a2 (six communication holes 24a in the present embodiment). One of the attaching regions 24 at the right end in the illustration in FIG. 5 has a communication hole 24a3 and a plurality of communication holes 24a2 (five communication holes 24a2 in the present embodiment). The communication hole 24a1 is in communication with the first internal space V1 on the most negative side in the stacking direction. The communication holes 24a2 each are in communication with its associated one of the second internal spaces V2 disposed in a middle in the stacking direction. The communication hole 24a3 is in communication with the third internal space V3 on the most positive side in the stacking direction.

The communication holes 24a have through holes 21h formed in the first seal portions 21 and through holes 12h formed in the second seal portion 12, respectively. The communication holes 24a function as inlet holes through which electrolyte is injected into the internal spaces V. After the electrolyte is injected, the communication holes 24a serve as flow paths through which gas (e.g., hydrogen gas) generated in the internal spaces V flows.

The second seal portion 12 has protrusions 27 for attachment in the attaching regions 24, and the protrusions 27 each have a substantially frame shape. The protrusions 27 each are used to connect the module main body 4A with the pressure control valves 22 by thermal welding, and form a plurality of intermediate spaces 28 (six intermediate spaces 28) through which gas from the internal spaces V flows. The intermediate spaces 28 may form part of injection holes and flow paths through which gas flows. The intermediate spaces 28 each have a rectangular shape in a cross section along a plane perpendicular to the X-axis direction. The protrusions 27 each are formed in a lattice shape as viewed in the Y-axis direction, and surround each of the plurality of communication holes 24a, separately.

The plurality of intermediate spaces 28 formed in one of the attaching regions 24 at the left end in the illustration in FIG. 5 include an intermediate space 281 in communication with the communication hole 24a1 and intermediate spaces 282 in communication with the communication holes 24a2. The plurality of intermediate spaces 28 formed in two attaching regions 24 disposed inward in the X-axis direction include only the intermediate spaces 282 in communication with the communication holes 24a2. The plurality of intermediate spaces 28 formed in one of the attaching regions 24 at the right end in the illustration in FIG. 5 include an intermediate space 283 in communication with the communication hole 24a3 and the intermediate spaces 282 in communication with the communication holes 24a2.

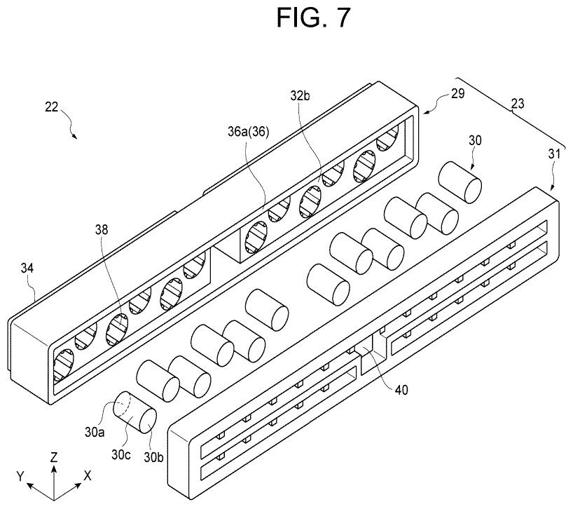

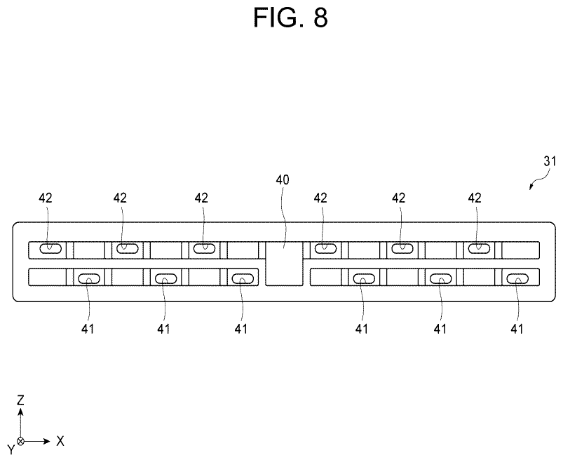

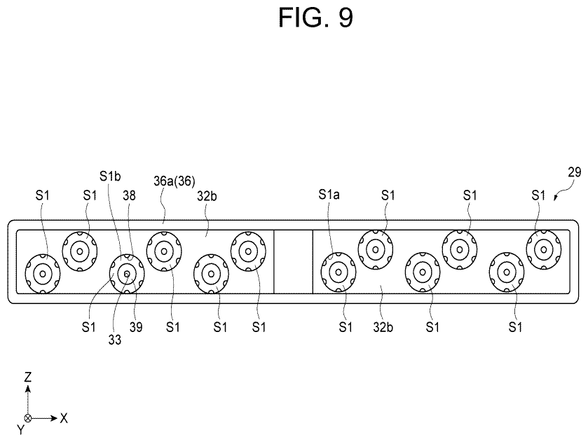

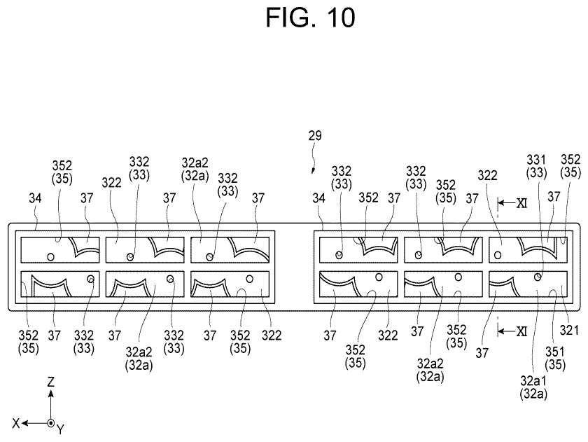

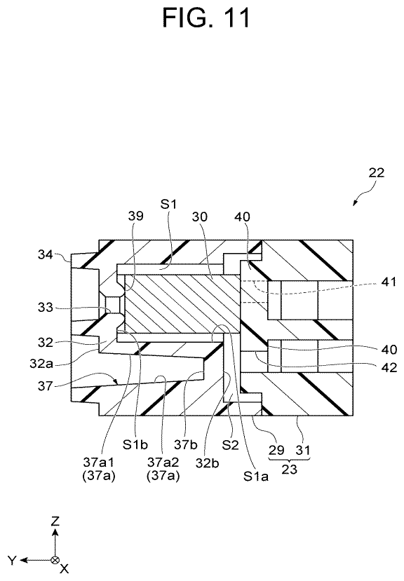

Next, the configuration each of the pressure control valves 22 to be attached to the module main body 4A will be described in detail. FIG. 7 is an exploded perspective view illustrating one of the pressure control valves. FIG. 8 is a plan view of a cover. FIG. 9 is a plan view of a case. FIG. 10 is a bottom view of the case. FIG. 11 is a cross-sectional view, taken along line XI-XI of FIG. 10.

As illustrated in FIGS. 6 to 11, the pressure control valves 22 each include a housing 23 and a plurality of valve bodies 30 (twelve valve bodies 30 in the present embodiment). The housing 23 includes a case 29 and a cover 31. The case 29 is made of a resin such as PP, PPS, or modified PPE, for example. The case 29 has a generally rectangular shape as viewed in a facing direction in which the case 29 faces the cover 31. The facing direction corresponds to an attaching direction in which the pressure control valves 22 are attached to one of the outer surfaces 12r of the module main body 4A, and also to a compressing direction of the valve bodies 30. The pressure control valves 22 are attached to the module main body 4A in a direction perpendicular to the one of the outer surfaces 12r. Therefore, the facing direction in which the case 29 faces the cover 31 coincides with the Y-axis direction.

The case 29 has a bottom wall 32 (wall body). The bottom wall 32 faces one of the outer surfaces 12r of the module main body 4A in the Y-axis direction. The bottom wall 32 has a plurality (twelve in the present embodiment) of through holes 33 (second communication holes) that extend through the bottom wall 32 in the Y-axis direction. The through holes 33 extend from the outer wall surface 32a facing the module main body 4A to the inner wall surface 32b facing the cover 31.

As illustrated in FIGS. 6 and 7, the case 29 has an outer peripheral wall 36 protruding from the bottom wall 32 towards the cover 31. In the present embodiment, the outer peripheral wall 36 is formed integrally with the bottom wall 32. The outer peripheral wall 36 is formed standing from an edge portion of the inner wall surface 32b of the bottom wall 32 so that the outer peripheral wall 36 surrounds the plurality of valve bodies 30 (twelve valve bodies 30 in the present embodiment) collectively. Specifically, the outer peripheral wall 36 is formed over the entire outer peripheral edge of the bottom wall 32, and forms an outer wall of the case 29. More specifically, the outer peripheral wall 36 is formed in a substantially rectangular frame shape extending along the outer peripheral edge of the bottom wall 32 having a substantially rectangular shape as viewed in the Y-axis direction.

In one example, accommodation spaces S1 each having a substantially columnar shape and accommodating the valve bodies 30 respectively are formed in the inner wall surface 32b. The accommodation spaces S1 each have an axis extending along the Y-axis direction, and each have a hollow shape extending from the inner wall surface 32b toward the outer wall surface 32a.

In the present embodiment, in a state in which the cover 31 is fixed to the case 29, the cover 31 is in contact with an end surface 36a of the outer peripheral wall 36, but the cover 31 and the inner wall surface 32b are spaced from each other. In other words, a space S2 is formed between the cover 31 and the inner wall surface 32b. The space S2 functions as a flow path for gas and electrolyte flowing into insides of the pressure control valves 22 from the internal spaces V.

The valve bodies 30 are accommodated in the accommodation spaces S1 in the housing 23 so as to close the through holes 33. The valve bodies 30 are arranged in the X-axis direction so as to close their associated through holes 33. The valve bodies 30 each are a columnar member formed of an elastic member such as rubber. The valve bodies 30 each have a first end surface 30a that closes its associated one of the through holes 33 on the inner wall surface 32b side of the bottom wall 32, a second end surface 30b opposite from the first end surface 30a, and a side surface 30c that connects the first end surface 30a with the second end surface 30b. The second end surface 30b is a surface to be pressed by the cover 31.

The valve bodies 30 each close its associated one of the through holes 33 with the first end surface 30a pressed against its associated one of the accommodation spaces S1. The valve bodies 30 open and close the through holes 33 depending on pressures in the internal spaces V. Gaps G are formed between the side surfaces 30c of the valve bodies 30 and inner wall surfaces S1a of the accommodation spaces S1.

As illustrated in FIGS. 7 and 9, protruded portions 38 for positioning the valve bodies 30 are formed in the inner wall surfaces S1a of the accommodation spaces S1. The protruded portions 38 protrude inward from the inner wall surfaces S1a of the accommodation spaces S1. The protruded portions 38 extend over the entire inner wall surfaces S1a of the accommodation spaces S1 along a direction in which a central axis of each of the through holes 33 extends (Y-axis direction). The protruded portions 38 are formed to be placed in contact with the side surfaces 30c of the valve bodies 30. With the protruded portions 38 placed in contact with the valve bodies 30, a central portion of each of the valve bodies 30 and the central axis of its associated one of the through holes 33 may coincide with each other. The protruded portions 38 restrict displacement of the valve bodies 30 to a certain range. In the present embodiment, a plurality of protruded portions 38 (six protruded portions 38 in the present embodiment) are disposed at regular pitches around the central axis of each of the through holes 33.

As illustrated in FIGS. 6 and 9, seal portions 39, which are protrusions protruding outward from the inner wall surface 32b, are formed in bottom surfaces S1b in the accommodation spaces S1. The seal portions 39 close clearances between the through holes 33 and the gaps G with the seal portions 39 placed in contact with the first end surfaces 30a of the valve bodies 30 pressed against the seal portions 39 so that the clearances may be opened and closed. The seal portions 39 are formed so as to surround open ends of the through holes 33 in the bottom surfaces S1b. The seal portions 39 each are formed in an annular shape extending along an edge portion of its associated one of the through holes 33 around the central axis of the one of the through holes 33. The seal portions 39 each surround the entire circumference of its associated one of the through holes 33 without a gap. Accordingly, the seal portions 39 are in contact with their associated first end surfaces 30a of the valve bodies 30 without gaps, thereby securing airtightness.

As illustrated in FIG. 10, a pair of protrusions 34 each having a substantially frame shape is provided for connection, and formed in the outer wall surface 32a of the bottom wall 32. The paired protrusions 34 are spaced from each other in the X-axis direction at an interval corresponding to an interval between the protrusions 27. The paired protrusions 34 connect the module main body 4A with the pressure control valves 22, and form a plurality of intermediate spaces 35 (twelve intermediate spaces 35 in the present embodiment) through which gas and electrolyte from the internal spaces V flow. The protrusions 34 are connected to the protrusions 27 of the module main body 4A. The protrusions 34 each have a shape and dimensions corresponding to its associated one of the protrusions 27. That is, the protrusions 34 each are formed in a lattice shape, as viewed in the Y-axis direction, and surround each of the through holes 33, separately.

The module main body 4A and the pressure control valves 22 are connected, for example, by hot plate welding. Specifically, a hot plate is disposed between the module main body 4A and the pressure control valves 22, and tips of the protrusions 27 and tips of the protrusions 34 are placed in contact with the hot plate. This melts the tips of the protrusions 27 and the protrusions 34. Then, the tips of the protrusions 34 are pressed against the tips of the protrusions 27 while the protrusions 27 and the protrusions 34 are melted, so that the protrusions 27 and the protrusions 34 are welded (connected). As a result, the module main body 4A and the pressure control valves 22 are connected. With the protrusions 27 and the protrusions 34 welded to each other, the intermediate spaces 28 and the intermediate spaces 35, which are disposed at positions corresponding to each other as viewed in the Y-axis direction, are connected. In a state where the protrusions 27 and the protrusions 34 are welded to each other, the through holes 33 are connected to their associated communication holes 24a of the module main body 4A. In other words, the intermediate spaces 28 and the intermediate spaces 35 provide connection between the communication holes 24a and the through holes 33 corresponding to each other.

The Intermediate space 35 may be classified into an intermediate space 351 (first intermediate space) and intermediate spaces 352 (second intermediate space). The intermediate space 351 is positioned at a lower right end when the illustration of FIG. 10 is viewed from the front. When one of the pressure control valves 22 is connected to the two attaching regions 24 on the left side in the illustration of FIG. 5, the intermediate space 351 is connected to the intermediate space 281 in communication with the communication hole 24a1. When the other of the pressure control valves 22 is connected to the two attaching regions 24 on the right side in the illustration of FIG. 5, the other of the pressure control valves 22 is arranged upside down, so that the intermediate space 351 is connected to the intermediate space 283 in communication with the communication hole 24a3. The intermediate spaces 352 are connected to intermediate spaces 282 in communication with the communication holes 24a2.

As illustrated in FIGS. 6 to 8, the cover 31 is a member that closes an opening of the case 29. The cover 31 has a side wall 40. The side wall 40 faces the bottom wall 32 of the case 29 in the Y-axis direction, across the valve bodies 30. The side wall 40 and the bottom wall 32 form a pair of walls of the housing 23 that face each other in the Y-axis direction. The cover 31 is made of a resin such as PP, PPS, or modified PPE. In one example, the cover 31 may be formed by injection molding. As viewed in the Y-axis direction, a position of an outer peripheral edge of the cover 31 substantially coincides with a position of an outer peripheral edge of the case 29 (the outer edge of the outer peripheral wall 36).

The cover 31 is connected to an open end surface of the case 29, for example, by welding such as ultrasonic welding. Specifically, an outer peripheral edge of the side wall 40 is welded to the end surface 36a of the outer peripheral wall 36 of the case 29. The side wall 40 has first holes 41 and second holes 42 that extend through the side wall 40 in the Y-axis direction. The second holes 42 are positioned vertically above the first holes 41. The first holes 41 and the second holes 42 are arranged so as not to overlap with the valve bodies 30 as viewed in the Y-axis direction. The first holes 41 and the second holes 42 are disposed so as to be next to the valve bodies 30 in the Z-axis direction as viewed in the Y-axis direction. The first holes 41 and the second holes 42 are arranged so as not to overlap with each other in the Z-axis direction. The first holes 41 and the second holes 42 are spaced in the X-axis direction so as not to overlap with each other as viewed in the Z-axis direction.

The first holes 41 and the second holes 42 can function as outlet ports for discharging (releasing) gas inside the pressure control valves 22 to an outside of the pressure control valves 22, or outlet ports for discharging electrolyte inside the pressure control valves 22 to the outside of the pressure control valves 22. In one example, the first holes 41 and the second holes 42 each have an elliptical shape with the X-axis direction as the longitudinal direction in a cross section perpendicular to the Y-axis direction. The first holes 41 and the second holes 42 have the same shape.

The side wall 40 is provided with a plurality of first holes 41 (six first holes 41 in the present embodiment) and a plurality of second holes 42 (six second holes 42 in the present embodiment). The first holes 41 are arranged in line in the X-axis direction. The second holes 42 are arranged in line in the X-axis direction. The first holes 41 and the second holes 42 are arranged alternately in the X-axis direction. Three first holes 41 and three second holes 42 are provided for each of the attaching regions 24.

The configuration of the case 29 is further described below. As illustrated in FIGS. 9 and 10, the through holes 33 formed in the case 29 include a through hole 331 and through holes 332. The through hole 331 is positioned so as to correspond to a position where the communication hole 24a1 is formed, as viewed in the Y-axis direction, and is in communication with the communication hole 24a1 through the intermediate space 351 and the intermediate space 281. The through holes 332 are positioned so as to correspond to positions where the communication holes 24a2 are formed, as viewed in the Y-axis direction, and are in communication with the communication holes 24a2 through the intermediate spaces 352 and the intermediate spaces 282.

As illustrated in FIGS. 10 and 11, the bottom wall 32 includes a first wall portion 321 having an outer wall surface 32a1 facing the intermediate space 351 and facing the frame 25, and a plurality of second wall portions 322 having outer wall surfaces 32a2, respectively, facing the intermediate spaces 352 and facing the frame 25. The outer wall surface 32a1 of the first wall portion 321 and the outer wall surfaces 32a2 of the second wall portions 322 are separated from each other by the protrusions 34. In addition, the outer wall surfaces 32a2 of the second wall portions 322 are also separated from each other by the protrusions 34.

The outer wall surfaces 32a1, 32a2 have recesses 37 recessed in a direction away from the frame 25. The recesses 37 extend along the axial direction (Y-axis direction) of the valve bodies 30 (accommodation spaces S1). As viewed in the Y-axis direction, the recesses 37 are formed so as to avoid the valve bodies 30 and do not overlap with the valve bodies 30. The recesses 37 each have an inner peripheral surface 37a, extending away from the frame 25 along the Y-axis direction toward the cover 31, and a bottom surface 37b, formed at an end of the inner surface 37a on the cover 31 side. The bottom surface 37b faces the frame 25, similar to the outer wall surfaces 32a. The recesses 37 each are formed so that a recess width is narrower as away from the frame 25, and the inner peripheral surface 37a is inclined relative to the Y-axis direction. In the inner peripheral surface 37a of each of the recesses 37, a wall surface 37a1 disposed next to its associated one of the valve bodies 30 is formed by a wall portion forming its associated one of the accommodation spaces S1. That is, each of the inner wall surfaces S1a forming the accommodation spaces S1 is positioned on a surface opposite to the wall surface 37a1 next to its associated one of the valve bodies 30, in the inner peripheral surface 37a. In other words, the wall surface 37a1 corresponds to one surface of the wall portion forming its associated one of the accommodation spaces S1, and each of the inner wall surfaces S1a corresponds to the other surface of the wall portion forming its associated one of the accommodation spaces S1.

In addition, a wall surface 37a2, which corresponds to another portion of the inner peripheral surface 37a of each of the recesses 37 and is not disposed next to the valve bodies 30, is formed by the outer peripheral wall 36. The bottom surface 37b is located on the opposite side of the inner wall surface 32b forming the space S2 in the bottom wall 32. For example, as viewed in the Y-axis direction, at least a portion of the edge portion of each of the recesses 37 may be formed along a peripheral edge of its associated one of the valve bodies 30. That is, of the inner peripheral surface 37a of each of the recesses 37, the wall surface 37a1 disposed side by side with its associated one of the valve bodies 30 may be curved so as to extend along an outer peripheral surface of the valve body 30 having a columnar shape.

As illustrated in FIG. 10, in one example, the protrusions 34 each are formed in a lattice shape surrounding the through holes 33. The through holes 33 positioned side by side along the X-axis direction are shifted from each other in the Z-axis direction. In the illustrated example, the accommodation spaces S1 accommodating the valve bodies 30 disposed side by side in the X-axis direction are shifted from each other in the Z-axis direction within a range in which such accommodation spaces S1 overlap with each other in the Z-axis direction. Therefore, as viewed in the Y-axis direction, an edge portion of each of the recesses 37 is formed so as to extend along portions of peripheral edges of two of the valve bodies 30 disposed side by side in the X-axis direction, and a portion of its associated one of the protrusions 34.

As described above, the power storage modules 4 of one example includes two pressure control valves 22 (a first pressure control valve 22A and a second pressure control valve 22B) (see FIG. 4). In an example of FIG. 4, the first pressure control valve 22A is disposed in the front (left) of the illustration, and the second pressure control valve 22B is disposed in the rear (right) of the illustration.

The first pressure control valve 22A and the second pressure control valve 22B to be attached to one module main body 4A are attached to the frame 25 in a state in which the first pressure control valve 22A and the second pressure control valve 22B are mutually reversed around a rotation axis along the Y-axis direction. That is, a top and a bottom of the first pressure control valve 22A and a top and a bottom of the second pressure control valve 22B are reversed. In the first pressure control valve 22A, the through hole 331 is in communication with the communication hole 24a1 in communication with the first internal space V1 via the intermediate space 351 and the intermediate space 281, and in the second pressure control valve 22B, the through hole 331 is in communication with the communication hole 24a3 in communication with the third internal spaces V3 via the intermediate space 351 and the intermediate space 283.

As have been described, the power storage modules 4 each include the module main body 4A including the electrode stack 11 in which a plurality of electrodes (the bipolar electrodes 14, the negative terminal electrode 18, and the positive terminal electrode 19) are stacked in the Z-axis direction, and the frame 25 that is disposed so as to surround the electrode stack 11 and seals the plurality of internal spaces V formed between the plurality of electrodes disposed side by side in the Z-axis direction, and the pressure control valves 22 attached to the frame 25. The frame 25 has a plurality of communication holes 24a in communication with the plurality of internal spaces V, respectively, and opened at one of the outer surfaces 12r of the frame 25. The pressure control valves 22 each include the bottom wall 32 that is made of resin, faces the frame 25, and has the plurality of through holes 33 in communication with the plurality of communication holes 24a, respectively, the protrusions 34 that protrude from the outer wall surface 32a (first wall surface) of the bottom wall 32 facing the one of the outer surfaces 12r of the frame 25 in the Y-axis direction intersecting with the Z-axis direction, and surround each of the through holes 33, separately, opened at the outer wall surface 32a, and the plurality of valve bodies 30 that close the plurality of through holes 33, respectively, from the inner wall surface 32b (second wall surface) side of the bottom wall 32 opposite from the outer wall surface 32a. The recesses 37 each are formed to be recessed in a direction away from the frame 25 and along the valve bodies 30, in a region of the outer wall surface 32a of the bottom wall 32 having an opening of one of the plurality of through holes 33 surrounded by one of the protrusions 34, the region not overlapping with the plurality of valve bodies 30 as viewed in the Y-axis direction.

In the above power storage modules 4, cells are formed by the electrodes disposed side by side in the Z-axis direction. A portion of the gas generated in the internal spaces V forming the cells can permeate the bottom wall 32 facing the intermediate spaces 35. Since the recesses 37 are formed in the outer wall surface 32a of the bottom wall 32, a surface area of the outer wall surface 32a exposed to the intermediate spaces 35 is increased, as compared with a case where the outer wall surface 32a is formed flat. As a result, a path for gas permeation is increased, thereby increasing the amount of gas permeating to an outside of the pressure control valves 22. Since the recesses 37 are formed along the valve bodies 30 in the region that does not overlap with the valve bodies 30, a space formed by the pressure control valves 22 can be used effectively, which suppresses an increase in size of the pressure control valves 22. As a result, an increase in size of the power storage modules 4 is suppressed.

The valve bodies 30 each have a columnar shape, and the protrusions 34 each may surround each of the through holes 33 separately in a rectangular frame shape, as viewed in the Y-axis direction. In this configuration, since the protrusions 34 each has a rectangular frame shape and the valve bodies 30 each have a circular shape, a region where the valve bodies 30 are not disposed is easily formed in a region inside each of the protrusions 34, and a space for forming the recesses 37 is easily secured.

As viewed in the Y-axis direction, at least a portion of the edge portions of the recesses 37 may be formed along the peripheral edges of the valve bodies 30. In this configuration, paths for gas permeation connecting a region where the recesses 37 are disposed with a region where the valve bodies 30 are disposed may be efficiently formed.

The valve bodies 30 may be arranged along the X-axis direction, which intersects with the Z-axis direction and Y-axis direction, and the positions of the valve bodies 30 disposed side by side in the X-axis direction may be shifted from each other in the Z-axis direction. In this configuration, the valve bodies 30 disposed side by side in the X-axis direction are arranged obliquely to the X-axis direction, which easily creates spaces for forming the recesses 37.

Although one example of the embodiment of the present disclosure has been described in detail, the present disclosure is not limited to the above embodiment.

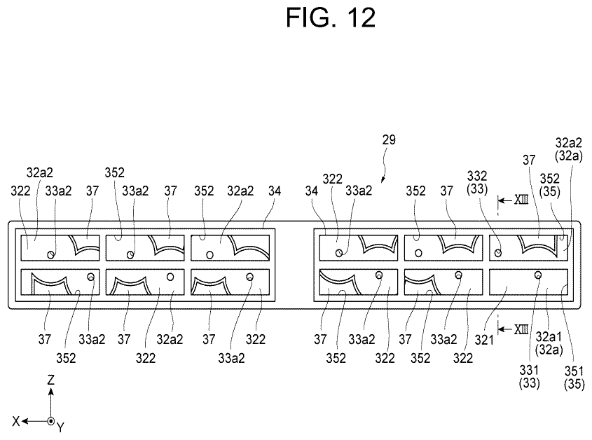

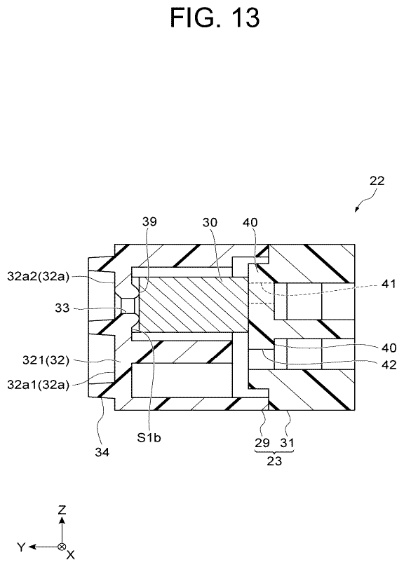

For example, FIG. 12 is a bottom view of a case according to another example, and FIG. 13 is a cross-sectional view taken along line XIII-XIII of FIG. 12. In the case illustrated in FIGS. 12 and 13, the recesses 37 are formed only in the outer wall surface 32a2 facing the intermediate spaces 352, and no recess 37 is formed in the outer wall surface 32a1 facing the intermediate space 351. The first wall portion 321 corresponding to the outer wall surface 32a1 is formed as thick as the thickness from the bottom surfaces S1b of the accommodation spaces S1 to the outer wall surface 32a.

The above power storage modules 4 each have outermost cells with a first internal space V1 (or a third internal space V3) and intermediate cells with the second internal spaces V2. Gas generated in the cells can permeate to the outside through the frame 25 that seals the peripheral edge of the electrode stack 11. In the intermediate cells located in the middle in the stacking direction, gas tends to permeate through the frame 25 generally along the horizontal direction (the X-axis direction and the Y-axis direction). On the other hand, in the outermost cells, which are located at outermost positions in the stacking direction, gas can permeate the frame 25 along the vertical direction (Z-axis direction), in addition to the horizontal direction. Therefore, the amount of gas permeated from the outermost cells tends to be greater than that from the intermediate cells.

In each of the power storage modules 4, the first internal space V1 is in communication with the intermediate space 351 via the communication hole 24a1, and the second internal spaces V2 are in communication with the intermediate spaces 352 via the communication holes 24a2. Therefore, a portion of gas generated in the first internal space V1, which forms the outermost cell, can permeate the first wall portion 321 facing the intermediate space 351. Similarly, a portion of gas generated in the second internal spaces V2, which form the intermediate cells, can permeate the second wall portions 322 facing the intermediate spaces 352.

In the case illustrated in FIGS. 12 and 13, the surface area of the outer wall surface 32a1 of the first wall portion 321 is smaller than that of each of the outer wall surfaces 32a2 of the second wall portions 322, so that the amount of gas permeating the first wall portion 321 is less than the amount of gas permeating the second wall portions 322. Therefore, the difference between the amount of gas permeation from the outermost cell and the amount of gas permeation from each of the intermediate cells may be reduced.

The gist of this disclosure may be described as follows
[1] a module main body having an electrode stack in which a plurality of electrodes is stacked in a first direction, and a frame that surrounds the electrode stack and seals a plurality of internal spaces formed between the plurality of electrodes disposed side by side in the first direction; and
   a pressure control valve attached to the frame, wherein
   the frame has a plurality of first communication holes in communication with the plurality of internal spaces, respectively, and opened at an outer surface of the frame,
   the pressure control valve includes:
      a wall body that faces the frame, is made of resin, and includes a plurality of second communication holes in communication with the plurality of first communication holes, respectively;
      a protrusion that protrudes from a first wall surface of the wall body facing the outer surface of the frame toward the frame along a second direction intersecting with the first direction, and surrounds each of the plurality of second communication holes separately, the plurality of second communication holes being opened at the first wall surface; and
      a plurality of valve bodies that closes the plurality of second communication holes, respectively, from a second wall surface of the wall body opposite from the first wall surface, and
   a recess is recessed in a direction away from the frame and along the valve bodies, in a region of the first wall surface of the wall body surrounded by the protrusion and having an opening of one of the plurality of second communication holes, the region not overlapping with the plurality of valve bodies as viewed in the second direction.
[2] The power storage module according to [1], wherein the plurality of valve bodies each has a columnar shape, and
the protrusion surrounds each of the second communication holes separately in a rectangular frame shape, as viewed in the second direction
[3] The power storage module according to [1] or [2], wherein at least a portion of an edge of the recess is formed along a shape of peripheral edges of the valve bodies, viewed in the second direction.
[4] the plurality of valve bodies elements are arranged along a third direction that intersects with the first direction and the second direction, and
positions of the valve bodies disposed side by side in the third direction are shifted from each other in the first direction.

### REFERENCE SIGNS LIST

4 power storage module
4A module main body
11 electrode stack
14 bipolar electrode (electrode)
18 negative terminal electrode (electrode)
19 positive terminal electrode (electrode)
22 pressure control valve
24a communication hole (first communication hole)
25 frame
30 valve body
32 bottom wall (wall body)
32a outer wall surface (first wall surface)
33 through hole (second communication hole)
37 recess
V internal space

1. A power storage module comprising:
a module main body including an electrode stack in which a plurality of electrodes are stacked in a first direction, and a frame that surrounds the electrode stack and seals a plurality of internal spaces formed between the plurality of electrodes disposed side by side in the first direction; and
a pressure control valve attached to the frame, wherein
the frame has a plurality of first communication holes in communication with the plurality of internal spaces, respectively, and opened at an outer surface of the frame,
the pressure control valve includes:
a wall body that faces the frame, is made of resin, and has a plurality of second communication holes in communication with the plurality of first communication holes, respectively;
a protrusion that protrudes along a second direction intersecting with the first direction toward the frame from a first wall surface of the wall body facing the outer surface of the frame, and surrounds each of the plurality of second communication holes separately, the plurality of second communication holes being opened at the first wall surface; and
a plurality of valve bodies that close the plurality of second communication holes, respectively, from a second wall surface of the wall body opposite from the first wall surface, and
a recess is formed to be recessed in a direction away from the frame and along the valve bodies, in a region of the first wall surface of the wall body surrounded by the protrusion and having an opening of one of the plurality of second communication holes, the region not overlapping with the plurality of valve bodies as viewed in the second direction.

2. The power storage module according to claim 1, wherein
the plurality of valve bodies each have a columnar shape, and
the protrusion surrounds each of the second communication holes separately in a rectangular frame shape, as viewed in the second direction

3. The power storage module according to claim 1, wherein at least a portion of an edge portion of the recess is formed along a shape of peripheral edges of the valve bodies, as viewed in the second direction.

4. The power storage module according to claim 1, wherein
the plurality of valve bodies are arranged along a third direction that intersects with the first direction and the second direction, and
positions of the valve bodies disposed side by side in the third direction are shifted from each other in the first direction.
